(19) United States
(12) Patent Application Publication
(10) Pub. No.: US 2014/0231196 A1
(43) Pub. Date: Aug. 21, 2014

(54) Brake disc with enhanced heat dissipation

(71) Applicant: Guan Yu Shih, Changhua (TW)

(72) Inventor: Guan Yu Shih, Changhua (TW)

(21) Appl. No.: 14/262,803

(22) Filed: Apr. 28, 2014

(51) Int. Cl. F16D 65/12; F16D 65/847

(52) U.S. Cl. CPC F16D 65/128; F16D 65/847
USPC 188/218 XL

(57) ABSTRACT

A brake disc is provided with a disc having two braking surfaces respectively formed at two sides thereof and an outer surface formed at the periphery thereof; a connecting hole disposed at the center of the disc; a plurality of through holes angularly spaced apart between the connecting hole and the outer surface, and each being deflectively radiated from the connecting hole toward the outer surface in counterclockwise direction so that an inner surface is formed at the disc corresponding to through holes adjacent to the outer surface and a first and second inner side surfaces are respectively formed toward and away from the counterclockwise direction; and a plurality of cooling fins extending outwardly from the second inner side surface toward the axial direction of the disc so that some parts are not in one plane except the connection of cooling fins and the second inner side surface.

### BACKGROUND OF THE INVENTION

1. Field of the Invention

The invention relates to a brake of a bicycle, and more particularly to a brake disc of a bicycle for enhancing heat dissipation.

2. Description of Related Art

In recent years, some bicycles have been provided with disc brakes. Disc brake systems provide a substantial braking power in relationship to the amount of braking force applied to the brake lever. Also, disc brake systems typically provide a high level of consistency in all types of weather and riding conditions. Disc brake systems typically include a caliper housing, a first movable brake pad and a second fixed or movable brake pad. Disc brakes can be hydraulically actuated or mechanically actuated for moving the movable brake pad(s). The brake pads are positioned on either side of a rotor, which is attached to the front or back wheel of a bicycle. The brake pads are pressed against a brake disc or rotor that is fixed to the wheel to slow down or stop the rotation of the disc, and thus, slow down or stop the rotation of the wheel.

However, the brake pads may be damaged seriously by the brake disc with heat generated from rubbing against the brake pads and the brake disc while pressing the brake pads.

Thus, the need for improvement still exists.

### SUMMARY OF THE INVENTION

It is therefore one object of the invention to provide a brake disc comprising a disc, being a rounded shape, and two braking surfaces are respectively formed at two sides of the disc in an axial direction and an outer surface is formed at the periphery of the disc; a connecting hole, disposed at the center of the disc for connecting with a center rotational axis of a wheel; a plurality of through holes, angularly spaced apart and arranged between the connecting hole and the outer surface formed at the periphery of the disc, and each through hole is deflectively radiated from the connecting hole toward the outer surface in counterclockwise direction so that an inner surface is formed at the disc corresponding to each through hole adjacent to the outer surface, a first inner side surface is formed toward the counterclockwise direction, and a second inner side surface is formed away from the counterclockwise direction; and a plurality of cooling fins, extending outwardly from the second inner side surface toward the axial direction of the disc for each so that some parts of each cooling fin are not in one plane except the connection of each cooling fin and the second inner side surface. Wherein the heat generated from each braking surface of the disc is dissipated through the cooling fins to enhance heat dissipation.

The above and other objects, features and advantages of the invention will become apparent from the following detailed description taken with the accompanying drawings.

### BRIEF DESCRIPTION OF THE DRAWINGS

FIG. 1 is a perspective view of a first embodiment of a brake disc with enhanced heat dissipation according to the invention;

FIG. 2 is a front view of the first embodiment of the brake disc with enhanced heat dissipation according to the invention;

FIG. 3 is a side view of the first embodiment of the brake disc with enhanced heat dissipation according to the invention;

FIG. 4 is a cross sectional view of the first embodiment of the brake disc with enhanced heat dissipation according to the invention;

FIG. 5 is a perspective view of a second embodiment of a brake disc with enhanced heat dissipation according to the invention;

FIG. 6 is a front view of the second embodiment of the brake disc with enhanced heat dissipation according to the invention;

FIG. 7 is a side view of the second embodiment of the brake disc with enhanced heat dissipation according to the invention;

FIG. 8 is a cross sectional view of the second embodiment of the brake disc with enhanced heat dissipation according to the invention;

FIG. 9 is a perspective view of a third embodiment of a brake disc with enhanced heat dissipation according to the invention;

FIG. 10 is a front view of the third embodiment of the brake disc with enhanced heat dissipation according to the invention;

FIG. 11 is a side view of the third embodiment of the brake disc with enhanced heat dissipation according to the invention; and

FIG. 12 is a cross sectional view of the third embodiment of the brake disc with enhanced heat dissipation according to the invention.

### DETAILED DESCRIPTION OF THE INVENTION

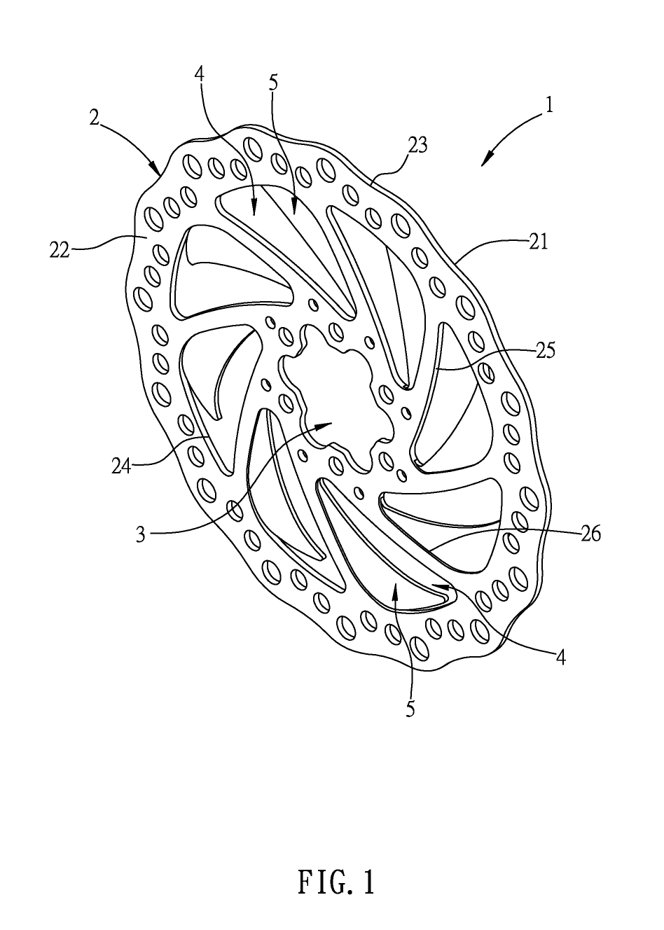

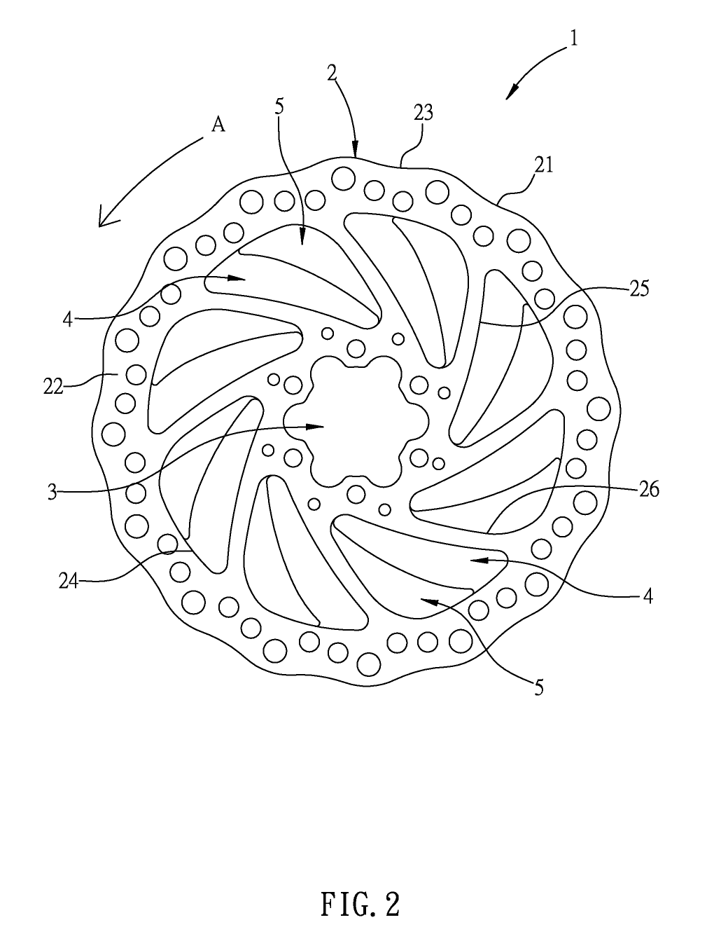

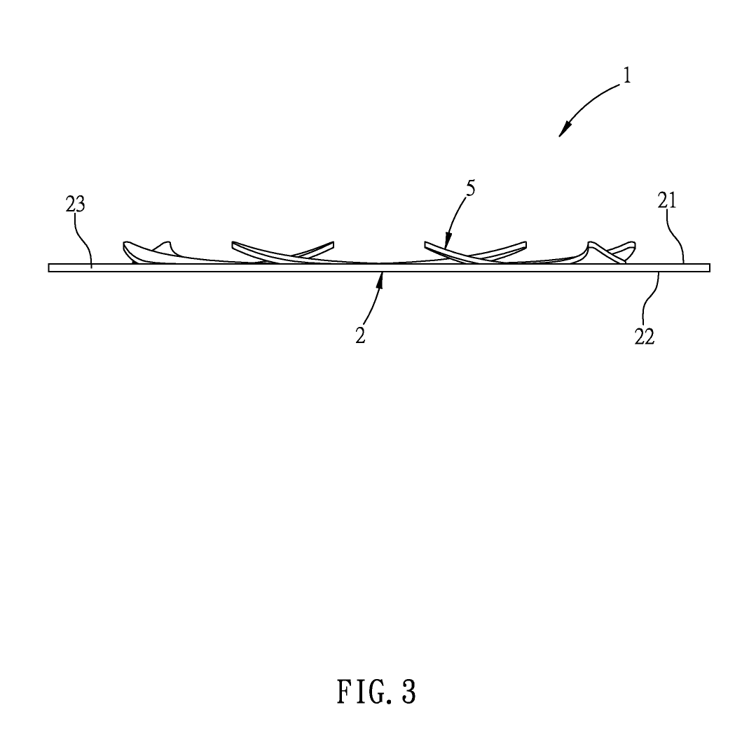

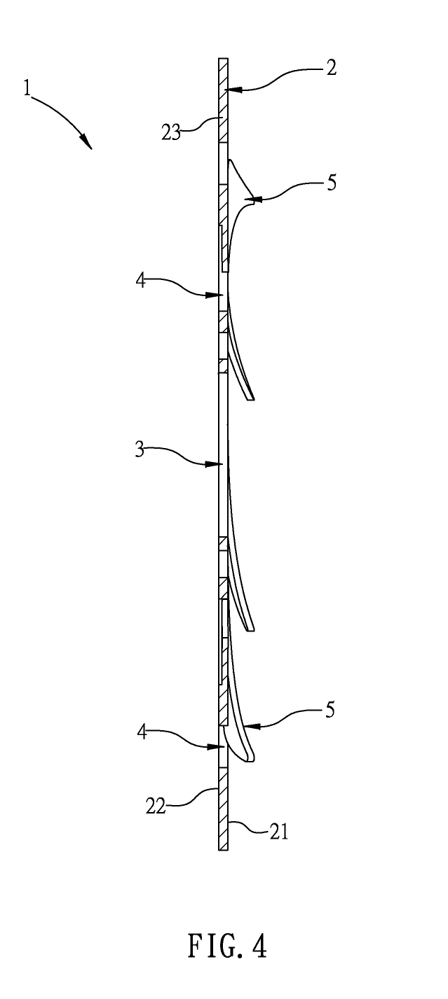

Referring to FIGS. 1 to 4, a disc brake 1 in accordance with a first preferred embodiment of the invention comprises a disc 2, a connecting hole 3, a plurality of through holes 4 and a plurality of cooling fins 5 as discussed in detail below.

The disc 2 may be substantially a rounded shape, and two braking surfaces 21 and 22 are respectively formed at two sides of the disc 2 in an axial direction and an outer surface 23 is formed at the periphery of the disc 2.

The connecting hole 3 may be disposed at the center of the disc 2 for connecting with a center rotational axis of a wheel (not shown).

Each through hole 4 may be angularly spaced apart and arranged between the connecting hole 3 and the outer surface 23 formed at the periphery of the disc 2. And each through hole 4 is deflectively radiated from the connecting hole 3 toward the outer surface 23 in a counterclockwise direction so that an inner surface 24 is formed at the disc 2 corresponding to each through hole 3 adjacent to the outer surface 23, a first inner side surface 25 is formed toward the counterclockwise direction, and a second inner side surface 26 is formed away from the counterclockwise direction.

Each cooling fin 5 may be extending outwardly from the second inner side surface 26 toward the axial direction of the disc 2 for each so that some parts of each cooling fin are not in one plane except the connection of each cooling fin and the second inner side surface 26. Each cooling fin 5 and the disc 2 may be integrally formed or welding together.

In this embodiment, each cooling fin 5 is a blade of a fan. Therefore, the cooling fins 5 are capable of deflecting wind so as to enhance heat dissipation. Besides, in this embodiment, the outward direction of each cooling fin 5 is toward the direction corresponding to one of the braking surfaces (braking surface 21 or 22).

Therefore, heat generated from each braking surface 21 and 22 of the disc 2 is dissipated through the cooling fins 5 to deflect wind and further to enhance heat dissipation.

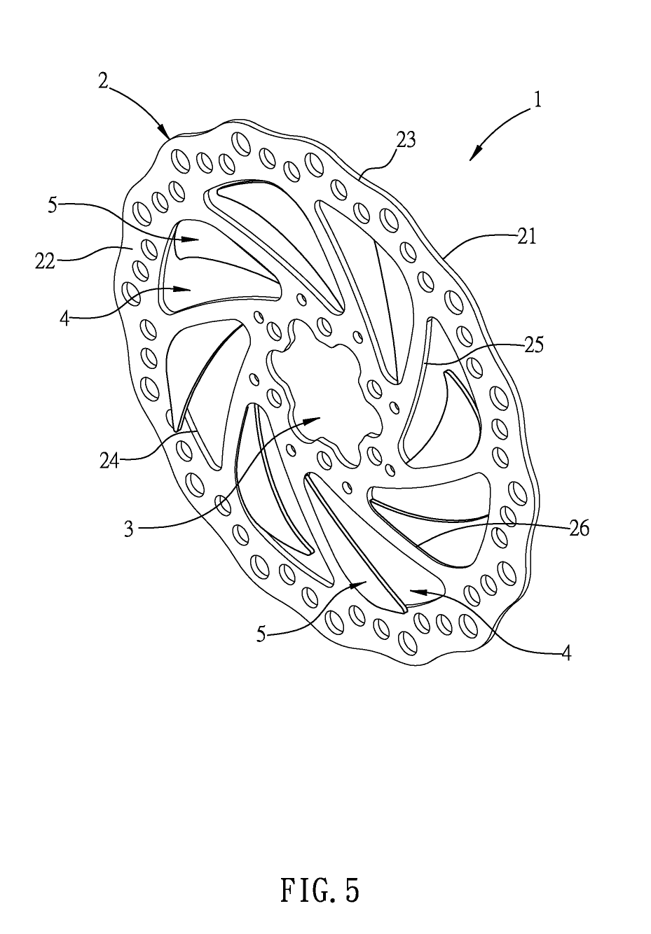

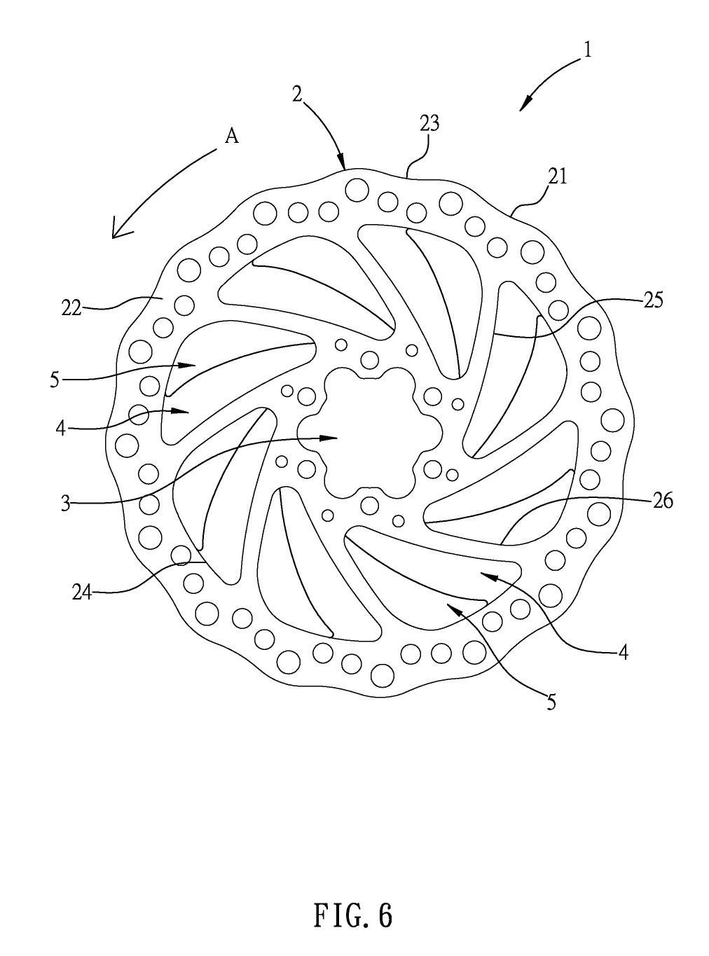

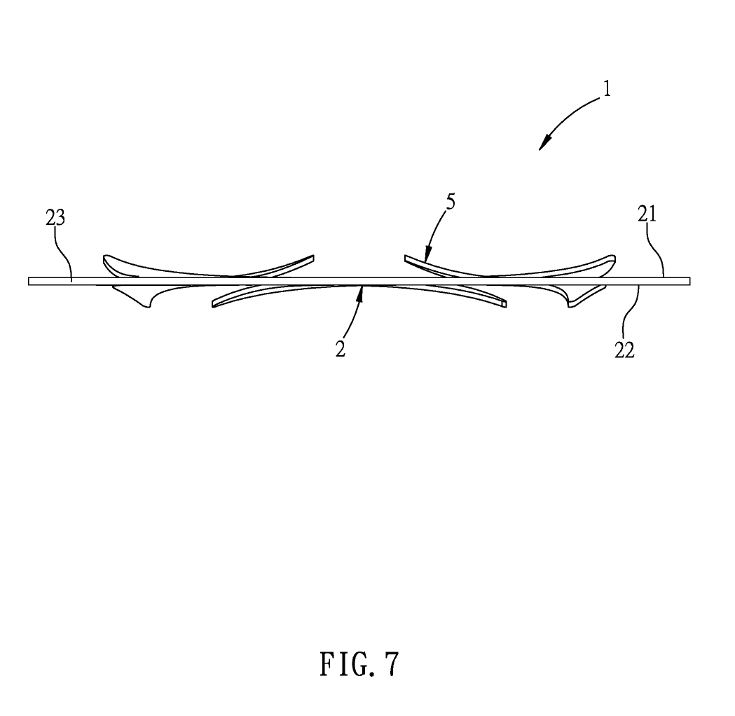

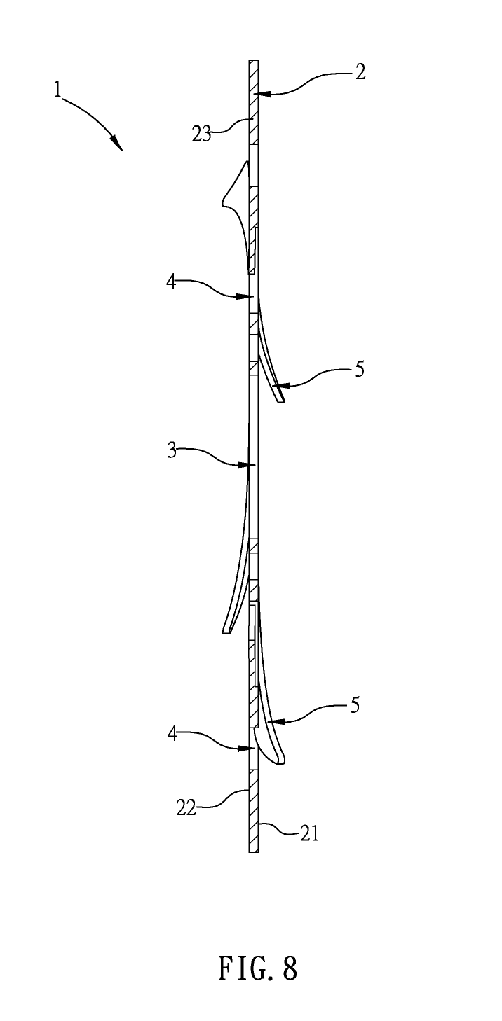

Referring to FIGS. 5 to 8, a disc brake 1 in accordance with a second preferred embodiment of the invention is shown. The characteristics of the second preferred embodiment are substantially the same as that of the first preferred embodiment except the following:

The outward direction of each cooling fin 5 is spaced apart and toward the direction corresponding to different braking surfaces 21 and 22. That is, the cooling fins 5 with odd numbers are extending toward the braking surface 21, and the cooling fins 5 with even numbers are extending toward the braking surface 22. Therefore, the second embodiment of the brake disc 1 is also capable of deflecting wind and further enhancing heat dissipation while heat is generated from the braking surface 21 and 22.

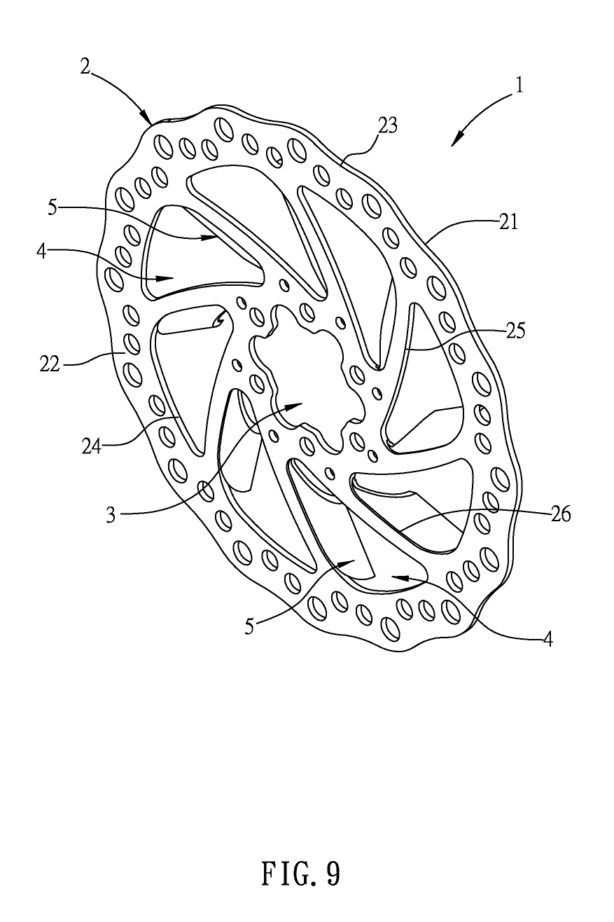

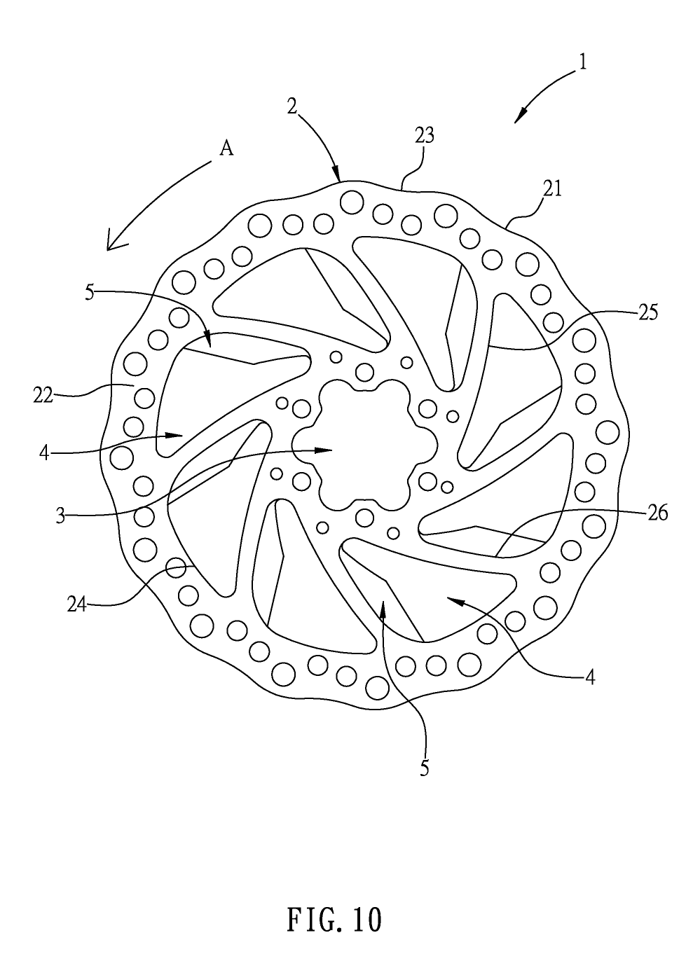

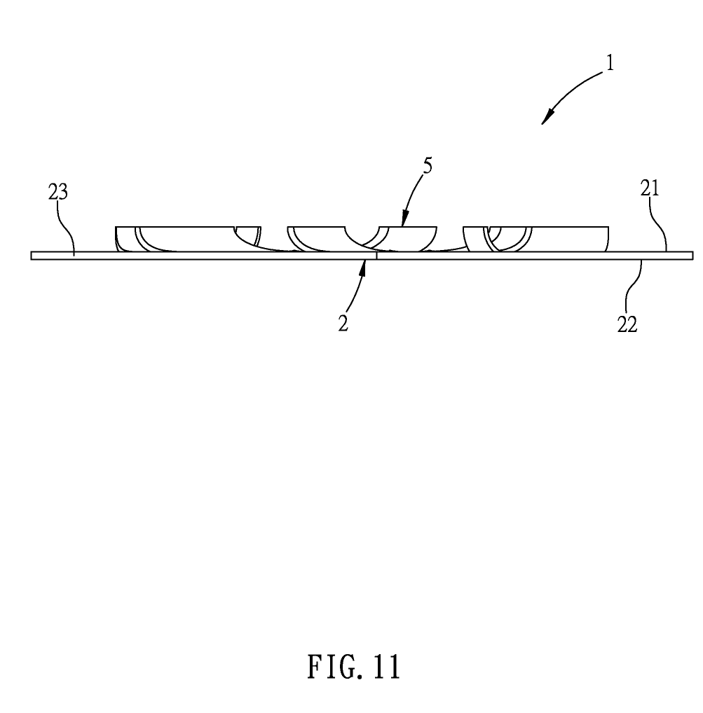

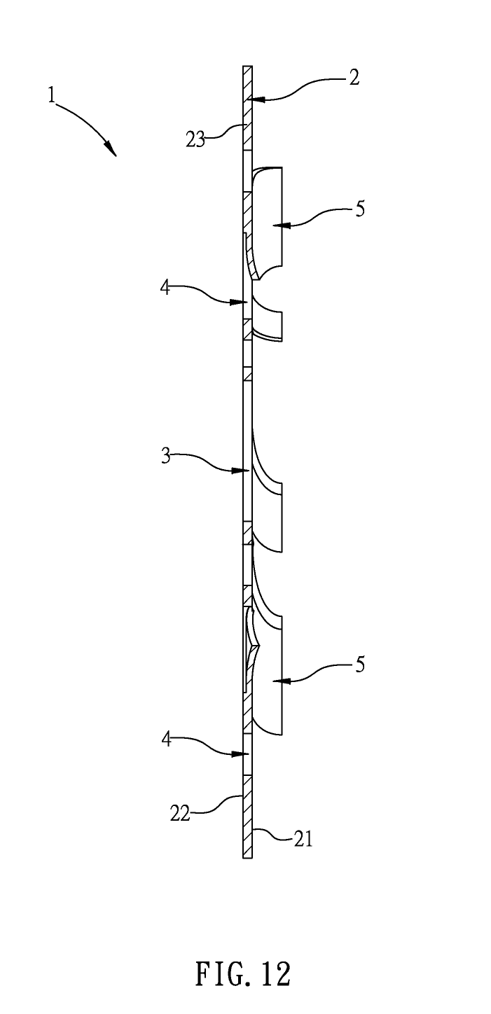

Referring to FIGS. 9 to 12, a disc brake 1 in accordance with a third preferred embodiment of the invention is shown. The characteristics of the third preferred embodiment are substantially the same as that of the first preferred embodiment except the following:

Each cooling fin 5 is arc. Therefore, the third embodiment of the brake disc 1 is also capable of deflecting wind and further enhancing heat dissipation while heat is generated from the braking surface 21 and 22.

While the invention has been described in terms of preferred embodiments, those skilled in the art will recognize that the invention can be practiced with modifications within the spirit and scope of the appended claims.

What is claimed is:

1. A brake disc comprising:
a disc being a rounded shape and including two braking surfaces formed on two sides of the disc in an axial direction respectively, and an outer surface formed on a periphery of the disc;
a connecting hole disposed at a center of the disc;
a plurality of through holes angularly spaced apart and arranged between the connecting hole and the outer surface formed on the periphery of the disc, each of the through holes being deflectively radiated from the connecting hole toward the outer surface in a counterclockwise direction so that an inner surface is formed on the disc corresponding to each of the through holes adjacent to the outer surface, a first inner side surface is formed toward the counterclockwise direction, and a second inner side surface is formed away from the counterclockwise direction; and
a plurality of cooling fins each extending outwardly from the second inner side surface toward the axial direction of the disc so that portions of each of the cooling fins are not in one plane except a connection of each of the cooling fins and the second inner side surface;
wherein heat generated from each of the braking surfaces of the disc is dissipated through the cooling fins.

2. The brake disc of claim 1, wherein each of the cooling fins is a blade of a fan or an arc.

3. The brake disc of claim 1, wherein the outward direction of each of the cooling fins is toward the direction corresponding to one of the braking surfaces.

4. The brake disc of claim 1, wherein the outward direction of each of the cooling fins is spaced apart and toward the direction corresponding to different braking surfaces.

5. The brake disc of claim 1, wherein each of the cooling fins and the disc are integrally formed or welded together.
